(19) United States
(12) Patent Application Publication
(10) Pub. No.: US 2025/0086706 A1
(43) Pub. Date: Mar. 13, 2025

(54) POS CREDIT SCORE INDICATOR

(71) Applicant: Wells Fargo Bank, N.A., San Francisco, CA (US)

(72) Inventors: Marjorie Summit Anzalone, San Francisco, CA (US); Darlene Goins, San Francisco, CA (US); Darius A. Miranda, San Francisco, CA (US)

(73) Assignee: Wells Fargo Bank, N.A., San Francisco, CA (US)

(21) Appl. No.: 18/244,150

(22) Filed: Sep. 8, 2023

(51) Int. Cl. G06Q 40/03; G06Q 20/20

(52) U.S. Cl. CPC G06Q 40/03; G06Q 20/20

(57) ABSTRACT

A computing system includes one or more processing circuits including one or more processors coupled to one or more memory devices, the one or more memory devices having instructions stored thereon that, when executed by the one or more processors, cause the one or more processors to receive an indication of a customer transaction associated with a customer, the indication of the customer transaction including a transaction amount. The instructions further cause the one or more processors to determine a credit score effect based on the transaction amount. The instructions further cause the one or more processors to generate display data including a credit score indicator indicative of the credit score effect. The instructions further cause the one or more processors to cause a graphical user interface, based on the display data, to be displayed to the customer prior to completion of the customer transaction.

### TECHNICAL FIELD

Aspects and embodiments of the present disclosure relate to systems and methods for providing customers with credit score indicators during transactions.

### BACKGROUND

Customers are typically unaware how their purchases affect their credit scores. For example, in some instances, the timing of purchases and/or the cost of purchases may affect the impact that those purchases have on customer credit scores. However, given the general lack of awareness by customers, customers often unknowingly make purchases at times and/or having prices that negatively impact their credit scores. Because credit scores influence a wide array of customer capabilities (e.g., the ability for customers to acquire low-interest loans, the ability for customers to open new lines of credit), customers strive to achieve and maintain high credit scores. Accordingly, purchases that inadvertently lower credit scores have a variety of negative impacts for customers.

### SUMMARY

One embodiment relates to a computing system. The computing system includes one or more processing circuits including one or more processors coupled to one or more memory devices, the one or more memory devices having instructions stored thereon that, when executed by the one or more processors, cause the one or more processors to receive an indication of a customer transaction associated with a customer, the indication of the customer transaction including a transaction amount. The instructions further cause the one or more processors to determine a credit score effect associated with the customer transaction based on the transaction amount. The instructions further cause the one or more processors to generate display data including a credit score indicator indicative of the credit score effect. The instructions further cause the one or more processors to cause a graphical user interface, based on the display data, to be displayed to the customer prior to completion of the customer transaction.

Another embodiment relates to a method. The method includes receiving an indication of a customer transaction associated with a customer, the indication of the customer transaction including a transaction amount. The method further includes determining a credit score effect associated with the customer transaction based on the transaction amount. The method further includes generating display data including a credit score indicator indicative of the credit score effect. The method further includes causing a graphical user interface, based on the display data, to be displayed to the customer prior to completion of the customer transaction.

Still another embodiment relates to a non-transitory computer-readable medium having instructions stored thereon that, when executed by at least one processing circuit of a computing system, cause operations including receiving an indication of a customer transaction associated with a customer, the indication of the customer transaction including a transaction amount. The operations further includes determining a credit score effect associated with the customer transaction based on the transaction amount. The operations further include generating display data including a credit score indicator indicative of the credit score effect. The operations further include causing a graphical user interface, based on the display data to be displayed to the customer prior to completion of the customer transaction.

This summary is illustrative only and is not intended to be in any way limiting. Other aspects, inventive features, and advantages of the systems, devices, or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment that provides credit indicators associated with customer transactions, according to an example embodiment.

FIG. 2 is flow diagram of a method for providing a credit score indicator and credit score suggestions to a customer performing a transaction, according to an example embodiment.

FIG. 3 is a graphical user interface providing a credit score indicator and credit score suggestions, according to an example embodiment.

FIG. 4 is a graphical user interface providing a credit score indicator and a credit score suggestion link, according to an example embodiment.

FIG. 5 is flow diagram of a method for providing a credit score indicator and credit score suggestions to a customer performing a transaction, according to an example embodiment.

FIG. 6 is a graphical user interface displayed on a customer device providing a credit score impact calculator tool, according to an example embodiment.

FIG. 7 is a graphical user interface displayed on a customer device providing a credit score impact alert, according to an example embodiment.

### DETAILED DESCRIPTION

Referring generally to the figures, systems and methods for providing credit score indicators indicative of credit score impacts associated with various transaction to customers are disclosed according to various embodiments herein. In some instances, the systems and methods provide the credit score indicators to customers prior to completion of attempted transactions, such that the customers are made aware of the credit score implications of the attempted transactions before choosing whether to proceed. Additionally, in some instances, the system and methods determine and provide customers with relevant credit score recommendations and corresponding action links configured to allow the customers to take action in real-time or near real-time to avoid negative credit score impacts associated with attempted transactions.

In some instances, the systems and methods described herein include and/or arrange the credit score recommendations within graphical user interfaces displayed to the customers based on an estimated relevance and/or usefulness of the credit score recommendations. For example, in some instances, the systems and methods described herein use one or more trained machine learning models to estimate the most relevant and/or useful credit score recommendations for a given customer. The systems and methods described herein then display only the credit score recommendations estimated to be the most relevant and/or useful to the customer and/or to arrange the credit score recommendations displayed to the customer in an order of estimated relevance and/or usefulness.

Accordingly, the systems and methods described herein provide a variety of improvements to transaction systems. For example, traditional transaction systems have not been configured to provide customers with real-time or near real-time credit impact information prior to completion of customer transactions. As such, customers have traditionally been unaware of how their purchases will affect their credit scores until after the purchases have been completed, at which point any negative impact on their credit scores will already have taken effect. Further, even if the customers were aware of how their purchases would affect their credit scores, traditional transaction systems have not provided actionable credit score recommendations that customers can perform prior to completion of their transactions to avoid negative credit score impacts.

The systems and methods described herein solve these issues by providing customers with the real-time or near real-time credit score indicators indicative of the credit score impacts of customer transactions and actionable, relevant, and useful credit score recommendations the customers can perform prior to completion of corresponding customer transactions. As such, customers are made aware of the credit score impacts associated with their purchases before any negative impacts on their credit scores have taken effect and are able to perform mitigating actions to avoid any potential negative credit score impacts.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

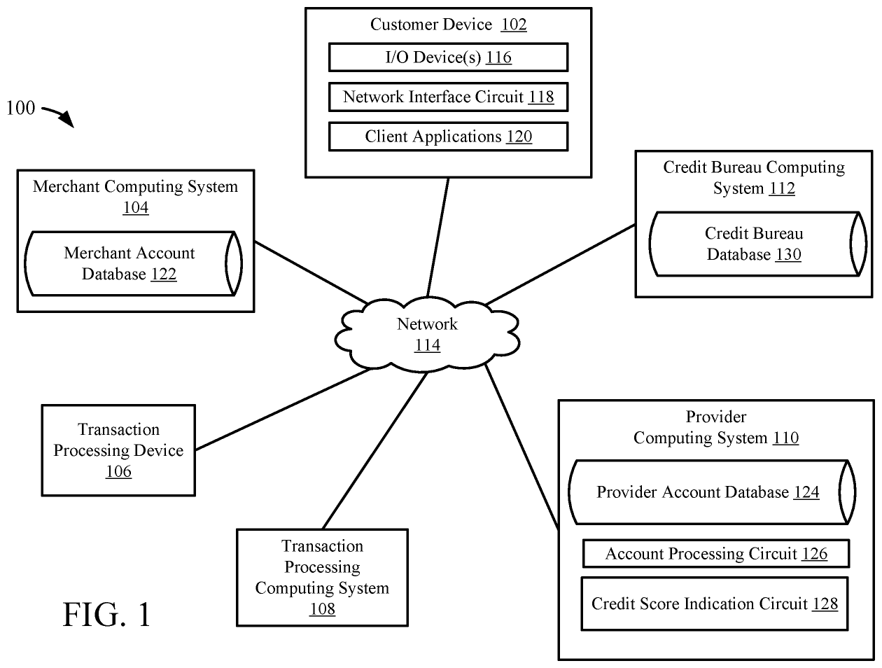

FIG. 1 is a diagram of a computing environment 100 that enables customers to receive real-time or near real-time indications of how a variety of customer transactions will affect their credit scores. As shown, the computing environment 100 includes a customer device 102, a merchant computing system 104, a transaction processing device 106, a transaction processing computing system 108, a provider computing system 110, and a credit bureau computing system 112. The various components of the computing environment are in communication with each other and are connected by a network 114.

Although the various systems and devices are shown in FIG. 1 as being singular, it will be understood that, in some instances, the computing environment 100 includes one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional merchant computing systems 104, additional customer devices 102, and so on).

The customer device 102 is owned, operated, controlled, managed, and/or otherwise associated with a customer (e.g., a customer making a purchase at a merchant associated with the merchant computing system 104). In some embodiments, the customer device 102 may be or may comprise, for example, a desktop or laptop computer (e.g., a tablet computer), a smartphone, a wearable device (e.g., a smartwatch), a personal digital assistant, and/or any other suitable computing device.

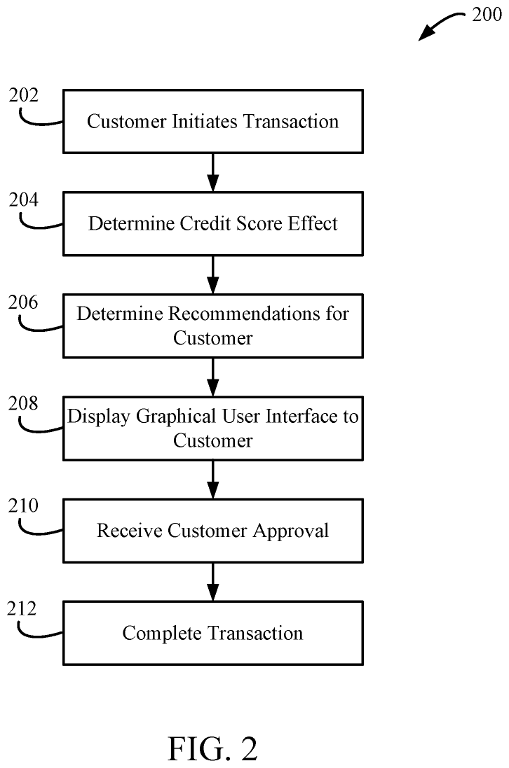

As shown in FIG. 2, in some embodiments, the customer device 102 includes one or more I/O devices 116, a network interface circuit 118, and one or more client applications 120. While the term “I/O” is used, it should be understood that the I/O devices 116 may be input-only devices, output-only devices, and/or a combination of input and output devices. In some instances, the I/O devices 116 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 116 further comprise one or more user interfaces (devices or components that interface with the customer), which may include one or more biometric sensors (such as a fingerprint reader, a heart monitor that detects cardiovascular signals, face scanner, an iris scanner, etc.).

The network interface circuit 118 includes, for example, program logic and various devices (e.g., transceivers, etc.) that connect the customer device 102 to the network 114. The network interface circuit 118 facilitates secure communications between the customer device 102 and various other components of the computing environment 100. The network interface circuit 118 also facilitates communication with other entities, such as other banks, settlement systems, and so on.

In some instances, the customer device 102 stores in computer memory, and executes (“runs”) using one or more processors, various client applications 120, such as an Internet browser presenting websites and/or applications provided or authorized by entities implementing or administering any of the computing systems in computing environment 100 to enable the customer to perform or otherwise interact with various methods and operations described herein.

For example, in some instances, the client applications 120 comprise a provider client application (e.g., a financial institution banking application) provided by and at least partly supported by the provider computing system 110 and configured to enable various functionality described herein. In some instances, the client applications 120 comprise a merchant client application provided by and at least partly supported by the merchant computing system 104 and configured to enable various functionality described herein.

In some instances, the client application 120 is additionally coupled to various components within the computing environment 100 (e.g., the merchant computing system 104, the provider computing system 110) via one or more application programming interfaces (APIs) and/or software development kits (SDKs) to integrate one or more features or services provided by the various components to enable the various methods and operations described herein. For example, in some instances, a provider client application provided to the customer device 102 by the provider computing system 110 implements various functionality of the merchant computing system 104 via one or more APIs and/or SDKs to allow for various functionality and/or information provided and/or stored by the merchant computing system 104 to be utilized or otherwise implemented within the context of the provider client application.

With reference again to FIG. 1, the merchant computing system 104 is controlled by, managed by, owned by, and/or otherwise associated with a merchant or service provider, such as a point-of-sale merchant or service provider (e.g., a physical retail store, a physical service provider location) or an online merchant or service provider (e.g., an online retailer, an online service provider). Accordingly, as used herein, the term “merchant” may refer to a physical or online, commercial or individual seller of goods, services, and/or any other tangible or intangible articles of commerce.

In some embodiments, the merchant computing system 104 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the merchant computing system 104 comprises and/or has various other devices communicably coupled thereto, such as, for example, desktop or laptop computers (e.g., tablet computers), smartphones, wearable devices (e.g., smartwatches), and/or other suitable devices.

As shown in FIG. 1, the merchant computing system 104 includes a merchant account database 122. In some instances, the merchant account database 122 stores various customer account information, customer preferences, customer account access credentials, customer payment method history, and various customer identifying information. In some instances, the merchant computing system 104 is configured to retrieve and transmit various customer data stored within the merchant account database 122 to various components within the computing environment 100 to enable the various methods, functions, and processes described herein.

Although not specifically shown, it will be appreciated that the merchant computing system 104 may similarly include various I/O devices (e.g., similar to I/O device(s) 116), a network interface circuit (e.g., similar to the network interface circuit 118), client applications (e.g., similar to client applications 120), additional databases, an account processing circuit (e.g., similar to the account processing circuit 126 of the provider computing system 110), and other circuits in the same or similar manner to the other components of computing environment 100. For example, in some instances, the merchant computing system 104 includes a network interface circuit having user interface program logic configured to generate and present application pages, web pages, and/or various other data to users accessing the merchant computing system 104 over the network 114.

In some instances, the transaction processing device 106 is owned, operated, controlled, managed, and/or otherwise associated with a transaction processing entity (e.g., Clover®, Square®) configured to process a variety of transactions (e.g., debit card transactions, credit card transactions, tap-to-pay transactions using a mobile device). For example, in some instances, the transaction processing entity provides the transaction processing device 106 (and other similar transaction processing devices) to various merchants to allow the merchants to conduct card-based transactions. In these instances, the transaction processing device 106 may be or may comprise a card terminal device configured to receive swipes, dips, and/or taps from various payment cards and/or other payment devices (e.g., a mobile wallet device with tap-to-pay functionality).

In some instances, a variety of different devices may be configured for use as the transaction processing device 106. For example, in some instances, a transaction processing application is provided by the transaction processing entity (e.g., via the transaction processing computing system 108) to a variety of devices to allow for the devices to perform the transaction processing functionality of the transaction processing device 106. For example, any of a desktop or laptop computer (e.g., a tablet computer), a smartphone, a wearable device (e.g., a smartwatch), a personal digital assistant, and/or any other suitable computing device may be configured for use as the transaction processing device 106, as desired for a given application. Accordingly, in some instances, the transaction processing device 106 is owned, operated, controlled, managed, and/or otherwise associated with the merchant and/or various other entities.

Although not specifically shown, it will be appreciated that the transaction processing device 106 may similarly include various I/O devices (e.g., similar to I/O device(s) 116), a network interface circuit (e.g., similar to the network interface circuit 118), client applications (e.g., similar to client applications 120), and other circuits in the same or similar manner to the other components of computing environment 100.

The transaction processing device 106 is communicably coupled with the transaction processing computing system 108, which is similarly owned, operated, controlled, managed, and/or otherwise associated with the transaction processing entity. For example, in some instances, the transaction processing device 106 is configured to transmit various transaction information from the point of sale to the transaction processing computing system 108 to be used to process various payments conducted at the merchant.

As an example of a traditional payment processing operation, in some instances, a customer may swipe, dip, or tap a payment card using the transaction processing device 106 at the merchant point-of-sale location to pay for a purchase. The transaction processing device 106 may then transmit various transaction information (e.g., the payment card information, purchase pricing) to the transaction processing computing system 108. The transaction processing computing system 108 may then transmit the payment card information to the merchant's financial institution (e.g., another provider computing system similar to the provider computing system 110), which then communicates with the customer's financial institution (e.g., the provider computing system 110) over an established payment network. The provider computing system 110 may then authorize and complete the payment for the purchase.

Although not specifically shown, it will be appreciated that the transaction processing device 106 and/or the transaction processing computing system 108 may each similarly include various I/O devices (e.g., similar to I/O device(s) 116), a network interface circuit (e.g., similar to the network interface circuit 118), client applications (e.g., similar to client applications 120), and other circuits in the same or similar manner to the other components of computing environment 100. For example, in some instances, the transaction processing computing system 108 includes a network interface circuit having user interface program logic configured to generate and present application pages, web pages, and/or various other data to users accessing the transaction processing computing system 108 over the network 114.

The provider computing system 110 is owned by, associated with, or otherwise operated by a provider institution (e.g., a bank or other financial institution) that maintains one or more accounts held by various customers (e.g., the customer associated with the customer device 102, the merchant associated with the merchant computing system 104), such as demand deposit accounts, credit card accounts, receivables accounts, and so on.

In some instances, the provider computing system 110, for example, comprises one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 110 comprises and/or has various other devices communicably coupled thereto, such as, for example, desktop or laptop computers (e.g., tablet computers), smartphones, wearable devices (e.g., smartwatches), and/or other suitable devices.

The provider computing system 110 includes a provider account database 124 that is structured or configured to retrievably store customer account information associated with various customer accounts (e.g., an account of the customer) held or otherwise maintained by the provider institution on behalf of its customers. In some instances, the customer account information includes both customer information and account information pertaining to a given customer account. For example, in some instances, the customer information includes a name, a phone number, an e-mail address, a physical address, a username, a credit score history, an income level (e.g., based on customer tax documents), etc. of the customer associated with the customer account. In some instances, the account information includes a listing of payment accounts associated with each customer account, information pertaining to the type and corresponding capabilities of each payment account, interest rates associated with each payment account, rewards rates associated with each payment account, historical purchase information (e.g., what was purchased, where was it purchased, how much did the purchase cost), recurring payment information, etc.

The provider computing system 110 further includes an account processing circuit 126 that is structured or configured to perform a variety of functionalities or operations to enable various customer activities in connection with customer account information stored within the provider account database 124. For example, in some instances, the account processing circuit 126 performs various functionalities to enable account opening and/or closing actions, various account transactions (e.g., debit transactions, credit transactions), and/or a variety of other services and functionalities associated with and/or provided by the provider institution and described herein.

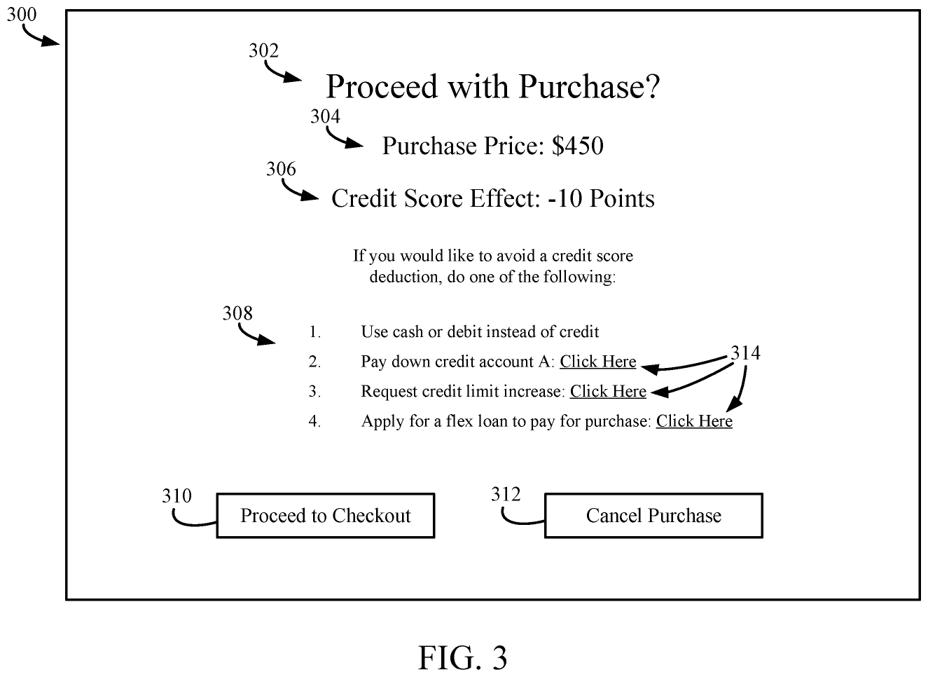

The provider computing system 110 further includes a credit score indication circuit 128 that is structured or configured to perform a variety of the functionalities described herein. As will be described in detail below, with regard to FIGS. 2 and 3, the credit score indication circuit 128 is configured to provide real-time or near real-time credit score indicators to customers before, during, and/or after the customers complete transactions. As used herein, the term “credit score indicator” is used to refer to an indication provided to a customer that is indicative of how a transaction or estimated transaction will affect the customer's credit score. As will similarly be described below, in some instances, the credit score indication circuit 128 is further configured to provided one or more suggestions to the customer regarding how to complete a given transaction or estimated transaction without negatively impacting the customer's credits score. In some instances, the credit score indication circuit 128 is additionally configured to enable the customer to take one or more actions associated with the suggestions provided to the customer.

Although not specifically shown, it will be appreciated that the provider computing system 110 may similarly include various I/O devices (e.g., similar to I/O device(s) 116), a network interface circuit (e.g., similar to the network interface circuit 118), client applications (e.g., similar to client applications 120), and other circuits in the same or similar manner to the other components of computing environment 100. For example, in some instances, the provider computing system 110 includes a network interface circuit having user interface program logic configured to generate and present application pages, web pages, and/or various other data to users accessing the provider computing system 110 over the network 114.

The credit bureau computing system 112 is controlled by, managed by, owned by, and/or otherwise associated with a credit reporting bureau entity (e.g., Experian®, Equifax®, TransUnion®) configured to monitor credit events for a variety of individuals and provide credit reporting (e.g., a FICO credit score) to potential creditors and provider institutions.

In some embodiments, the credit bureau computing system 112 may, for example, comprise one or more servers, each with one or more processing circuits including one or more processors configured to execute instructions stored in one or more memory devices, send and receive data stored in the one or more memory devices, and perform other operations to implement various operations described herein. In some instances, the credit bureau computing system 112 comprises and/or have various other devices communicably coupled thereto, such as, for example, desktop or laptop computers (e.g., tablet computers), smartphones, wearable devices (e.g., smartwatches), and/or other suitable devices.

As shown in FIG. 1, the credit bureau computing system 112 includes a credit bureau database 130. In some instances, the credit bureau database 130 stores various credit reporting information (e.g., credit events, outstanding debt, credit account history, credit utilization ratios) associated with individuals. In some instances, the credit bureau computing system 112 is configured to retrieve and transmit various credit reporting information stored within the credit bureau database 130 to various components within the computing environment 100 (e.g., the credit score indication circuit 128 of the provider computing system 110) to enable the various methods, functions, and processes described herein.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 2, a flow diagram of a method 200 for providing a credit score indicator and credit score suggestions to a customer performing a transaction is shown, according to an example embodiment. In some instances, the method 200 is performed or otherwise executed using various components of the computing environment 100.

The method 200 begins with the customer initiating a transaction, at step 202. For example, in some instances, the customer may initiate a transaction at a point of sale associated with the merchant by scanning one or more items at a point-of-sale device (e.g., the transaction processing device 106) associated with or otherwise in communication with the merchant computing system 104. In some other instances, the customer may initiate the transaction by placing one or more items within a virtual shopping cart while using a merchant client application (e.g., one of the client applications 120) or a website supported by or otherwise managed by the merchant.

The customer may then initiate a payment for the transaction. For example, for an in-store or point-of-sale purchase, the customer may swipe, tap, or dip a physical payment card associated with an account held by the provider institution (e.g., stored within the provider account database 124) to pay for the transaction. In some instances, instead of a physical payment card, the customer may attempt to pay for the transaction using a virtual payment card associated with the account held by the provider institution and stored within a mobile wallet on the customer device 102. For example, in some instances, the customer device 102 is equipped with a near-field communication device that may be tapped to a point-of-sale device (e.g., the transaction processing device 106) associated with or otherwise in communication with the merchant computing system 104. In the case of a transaction initiated via a mobile client application or website associated with the merchant, the client may enter or scan a payment card number (e.g., associated with a physical or virtual payment card) to pay for the transaction.

Once the customer has initiated the transaction, the credit score indication circuit 128 of the provider computing system 110 is configured to detect the initiated transaction and determine a potential effect of the initiated transaction on the customer's credit score (e.g., the customer's FICO credit score), at step 204. For example, in some instances, when the customer initiates the transaction, a transaction request is routed to the provider computing system 110 over an established payment network (e.g., VISAR, Mastercard®, American Express®). The transaction request may include various transaction information pertaining to the transaction that the customer is attempting to complete. For example, in some instances, the transaction information includes a purchase price and an indication of the customer account associated with the transaction request.

In some instances, upon receiving the transaction request, the provider computing system 110 (e.g., the credit score indication circuit 128) automatically performs a real-time or near real-time credit check for the customer by requesting or otherwise pulling (e.g., via one or more APIs) various credit report information (e.g., credit events, outstanding debt, credit account information, credit account history, credit utilization ratios) associated with the customer from the credit bureau computing system 112 (e.g., the credit bureau database 130).

Once the provider computing system 110 has obtained the credit report information associated the customer, the credit score indication circuit 128 may then determine the effect that the requested transaction would have on the customer's credit score based on the customers credit report information and the purchase amount associated with the transaction. For example, in some instances, the credit score indication circuit 128 determines, based on one or more established credit scoring rules (e.g., associated with a FICO credit scoring model), that the intended purchase would improve (i.e., raise) or degrade (i.e., lower) the customer's credit score by a certain amount of points (e.g., adding 10 points or subtracting 10 points). In some instances, the credit score indication circuit 128 determines, based on the one or more established credit scoring rules that the customer's credit score would not be affected by the intended purchase (e.g., no points would be added or subtracted).

In addition to determining the effect that the intended purchase may have on the customer's credit score, the credit score indication circuit 128 may also determine one or more recommendations to provide to the customer, at step 206. In various examples, the recommendation is related to the intended purchase. For example, in some instances, the credit score indication circuit 128 determines various recommendations for the customer based on the customer's credit report information, the purchase amount, and/or a variety of customer-specific information associated with the customer (e.g., pulled from the customer account associated with the customer and stored within the provider account database 124).

As an example, in some instances, the recommendations include recommending that the customer use an alternative payment method (e.g., cash or a debit card) to make the purchase instead of a credit card (e.g., to maintain a lower credit utilization ratio). In other examples, the alternative payment method may be a crypto currency, digital currency, or other form of payment. In some instances, the recommendations include recommending that the customer pay off or pay down one or more credit card account balances prior to making the purchase (e.g., in real-time or near real-time). In some instances, the recommendations include recommending that the customer request a real-time or near real-time credit limit increase (e.g., to reduce his or her credit utilization ratio). For example, in some instances, the credit score indication circuit 128 may determine (e.g., based on received tax documents) that the customer's income has increased, such that the customer is likely eligible for a credit limit increase. In some instances, the recommendations include recommending that the customer use a flex loan option provided by the provider institution to pay for the purchase instead of a credit card. In various examples, a flex loan includes a loan which is instantly available to a customer and repayable through regular installments (e.g., monthly payments). In some examples, flex loans are for a small-dollar amount (e.g., $100, $250, or $500), and carry an associated flat fee (e.g., $10 or $15 flat fee) instead of an interest rate. Flex loans may be digitally available, e.g., through a mobile application of the provider institution, providing customers with a quick, secure, and transparent way to access funds.

In some instances, the credit score indication circuit 128 determines various recommendations based on a purchase history of the customer (e.g., recurring payments). For example, if the customer is about to make a purchase that, on its own, would not affect the customer's credit score, but paired with an upcoming recurring payment (e.g., annual homeowner taxes, car insurance bills) would negatively impact the customer's credit score, the credit score indication circuit 128 may recommend that the customer either refrain from making the purchase using a credit card or pay down one or more credit card balances before the recurring payment is scheduled to occur.

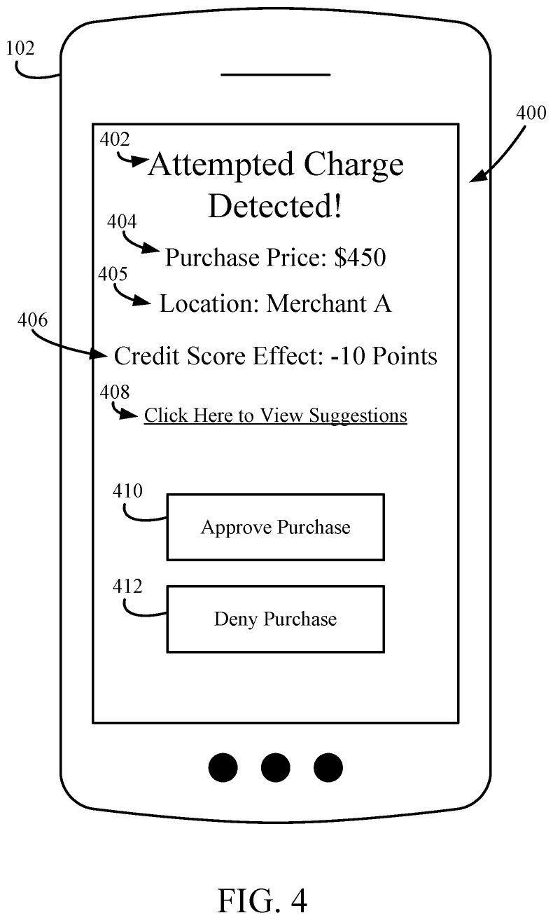

Once the credit score indication circuit 128 has determined the credit score effect and various recommendations, the credit score indication circuit 128 may then generate a graphical user interface (e.g., graphical user interfaces 300, 400) to be displayed to the customer, at step 208. For example, in some instances, the credit score indication circuit 128 is configured to transmit a user interface (e.g., graphical user interface 300 shown in FIG. 3) to the transaction processing device 106 to be displayed to the customer at the point of sale. In some instances, the credit score indication circuit 128 is configured to transmit a user interface (e.g., graphical user interface 400 shown in FIG. 4) to the customer device 102.

For example, referring to FIG. 3, a graphical user interface 300 is shown, according to an example embodiment. In some instances, the graphical user interface 300 is generated by the credit score indication circuit 128 and transmitted to the transaction processing device 106 or another device associated with the merchant computing system 104 to be displayed to the customer at a point of sale. It should be appreciated that the graphical user interface 300 (or a similar graphical user interface) may also be provided to the customer during an online transaction with an online merchant (e.g., via the customer device 102).

As illustrated, the graphical user interface 300 includes a prompt 302, a purchase price indication 304, a credit score indicator 306, a plurality of credit score recommendations 308, a proceed to checkout button 310, and a cancel purchase button 312. The prompt 302 asks the customer whether the customer wants to complete the purchase as requested or initiated (e.g., by scanning items at a point-of-sale device associated with the merchant computing system 104). The purchase price indication 304 is an indication of the current purchase price based on the requested or otherwise initiated transaction.

As illustrated, in some instances, the credit score indicator 306 is a text prompt indicating a specific credit score effect (e.g., “−10 points”) based on the credit score effect determined at step 204, as discussed above. In other instances, the credit score indicator 306 may comprise a variety of other text-based, color-based, or symbol-based indicators indicative of the determined credit score effect. For example, the credit score indicator 306 may comprise one or more of a color-coded indicator (e.g., a red indicator indicates that the intended purchase will reduce the customer's credit score by 10 or more points, a yellow indicator indicates that the intended purchase will reduce the customer's credit score between 1 and 10 points, and a green indicator indicates that the intended purchase will have no effect or a positive effect on the customer's credit score), a predetermined shape-based symbol (e.g., a plus sign or an upward arrow indicates that the transaction will have a positive effect on the customer's credit score, an equals sign or an empty circle indicates that the transaction will have no effect on the customer's credit score, a minus sign or a downward arrow indicates that the transaction will have a negative effect on the customer's credit score), or any other suitable type of credit score indicator or combination of indicators.

In some instances, the plurality of credit score recommendations 308 comprises one or more of the recommendations determined for the customer at step 206, discussed above. For example, in some instances, the plurality of credit score recommendations 308 comprises recommending that the customer use cash or debit instead of credit, that the customer pay down one or more credit accounts prior to completing the purchase, that the customer request a real-time credit limit increase on one or more accounts, and that the customer apply for a flex loan to pay for the purchase. In some other instances, the plurality of credit score recommendations 308 includes additional or alternative recommendations, as desired for a given application.

In some instances, the plurality of credit score recommendations 308 further includes one or more action links 314 associated with corresponding credit score recommendations 308. Each of the action links 314 is configured to allow the customer to perform the corresponding credit score recommendation 308 in real-time during the customer's interaction with the merchant (e.g., via the transaction processing device 106 or via the customer device 102). For example, as depicted in FIG. 3, in some instances, the action links 314 allow the customer to pay down one or more credit accounts prior to completing the purchase, to request a real-time credit limit increase on one or more accounts, and to apply for a flex loan to pay for the purchase. In some instances, upon clicking (e.g., using an input device such as a mouse, or a finger when using a touch-enabled display device) on one of the action links 314, the credit score indication circuit 128 generates a prompt requesting authentication information for the clicked link (e.g., account numbers, password credentials, personal identification numbers, date of birth, social security number) to allow for the customer to complete the recommended action.

Accordingly, from the graphical user interface 300, the customer may select to perform one of the credit score recommendations 308 by selecting a corresponding action link 314, proceed with the purchase as requested or initiated by selecting the proceed to checkout button 310, or cancel the purchase by selecting the cancel purchase button 312. In some instances, the customer may select to cancel the purchase to allow the customer to re-initiate the purchase using cash or debit based on the credit score recommendation 308. In some instances, the graphical user interface 300 includes a switch payment method button (e.g., similar to the proceed to checkout button 310) that allows for the customer to use a different payment method (e.g., cash or debit) instead of having to cancel and restart the transaction.

Referring now to FIG. 4, a graphical user interface 400 is shown on the customer device 102, according to an example embodiment. In some instances, the graphical user interface 400 is generated by the credit score indication circuit 128 and transmitted to the customer device 102 upon detection of the customer initiating a transaction, at step 202. For example, in some instances, if the customer attempts to use a credit card associated with an account held by the provider (e.g., stored within the provider account database 124), the account processing circuit 126, upon receiving the attempted transaction indication (e.g., via an established payment network), automatically pauses the transaction and indicates to the credit score indication circuit 128 that the customer is attempting to complete a transaction. In some instances, the credit score indication circuit 128 then automatically generates and transmits the graphical user interface 400 to the customer device 102 associated with the customer.

For example, in some instances, the provider account database 124 includes indications of devices associated with each customer account (e.g., device identifiers, phone numbers, banking application accounts), such that the credit score indication circuit 128 can transmit the graphical user interface 400 to the customer device 102 using any of a push notification, a pop-up within a provider banking application (e.g., one of the client applications 120), a text message including a selectable link, or any other suitable method.

In any case, as illustrated, the graphical user interface 400 includes a prompt 402, a purchase price indication 404, a merchant location indication 405, a credit score indicator 406, a credit score recommendation link 408, an approve purchase button 410, and a deny purchase button 412. In some instances, the purchase price indication 404 and the credit score indicator 406 are substantially the same as the purchase price indication 304 and the credit score indicator 306 discussed above, with respect to the graphical user interface 300 shown in FIG. 3. As such, the description above, with respect to the purchase price indication 304 and the credit score indicator 306 is similarly applicable to the purchase price indication 404 and the credit score indicator 406.

As shown in FIG. 4, the prompt 402 indicates that an attempted charge has been detected on the customer's account and the merchant location indication 405 provides the customer with an indication of the merchant location where the attempted charge has occurred. The credit score recommendation link 408 is selectable on the graphical user interface 400 to allow the customer to view a plurality of credit score recommendations and corresponding action links. For example, in some instances, upon clicking (e.g., using an input device such as a mouse, or a finger when using a touch-enabled display device) the credit score recommendation link 408, the customer is presented with a pop-up window or another graphical user interface (e.g., similar to the graphical user interface 300) including credit score recommendations and/or action links similar to the credit score recommendations 308 and corresponding action links 314 discussed above.

Accordingly, the graphical user interface 400 alerts the customer to the attempted charge, informs the customer of the merchant location where the purchase was attempted and the potential effect of the purchase on the customer's credit score, and provides the customer with various credit score recommendations and corresponding action links to allow the customer to take immediate action to avoid a negative impact to his or her credit score. The customer may then choose to perform one or more of the credit score recommendation actions by selecting the credit score recommendation link 408, approve the purchase as attempted by selecting the approve purchase button 410, or deny the purchase by selecting the deny purchase button 412.

It should be appreciated that, by transmitting the graphical user interface 400 directly to the customer device 102 upon detecting the attempted transaction received over the established payment network, as opposed to transmitting the graphical user interface 300 to the merchant computing system 104 and/or the transaction processing device 106, the provider computing system 110 (e.g., the credit score indication circuit 128) may not need to directly communicate with the merchant computing system 104, the transaction processing device 106, and/or the transaction processing computing system 108.

In some instances, graphical user interfaces described above (e.g., graphical user interface 300, graphical user interface 400) are arranged differently and/or include additional or fewer elements, as desired for a given application. For example, in some instances, credit score recommendations (e.g., the credit score recommendations 308 shown within the graphical user interface 300 and/or similar credit score recommendations presented to the customer upon the customer selecting the credit score recommendation link 408 on the graphical user interface 400) may be arranged within any of the graphical user interfaces based on their estimated relevance and/or usefulness to the customer.

For example, in some instances, the credit score indication circuit 128 is configured to estimate the most relevant and/or useful credit score recommendations for inclusion within the corresponding graphical user interface (e.g., graphical user interface 300, graphical user interface 400) using one or more machine learning models of the credit score indication circuit 128. In some instances, the credit score indication circuit 128 trains the one or more machine learning models to identify the most relevant and/or useful credit score recommendations for inclusion using various training data. In some instances, the training data comprises historical utilization of credit score recommendations by various customers, historical credit score information associated with various customers, historical account balance information associated with various customers, historical credit utilization ratios associated with various customers, established credit scoring rules, etc. For example, in some instances, at least a portion of the training data is data compiled over time from a variety of customers associated with the provider and stored within a database associated with the provider computing system 110 (e.g., the provider account database 124).

Accordingly, once the one or more machine learning models have been trained, the credit score indication circuit 128 may apply various customer information pertaining to the customer (e.g., credit score, account balances, credit utilization ratio, income level), as well as the purchase price and intended customer account to be used, to the one or more machine learning models to identify the most relevant and/or useful credit score recommendations for inclusion on the corresponding graphical user interface (e.g., one of the graphical user interfaces 300, 400).

In some instances, the credit score indication circuit 128 (e.g., the one or more machine learning models) may further determine that additional and/or updated information may be useful for determining the most relevant and/or useful credit score recommendations. In these instances, the credit score indication circuit 128 may transmit a prompt to the customer device 102 asking the customer to provide the additional and/or updated information. For example, in some instances, the credit score indication circuit 128 may determine that the customer has not updated his or her income in more than a predetermined amount of time (e.g., a year). Accordingly, in these instances, the credit score indication circuit 128 may generate and transmit a prompt to the customer device 102 asking the customer to provide an updated income level.

In some instances, the credit score indication circuit 128 further arranges the credit score recommendations according to their estimated relevance and/or usefulness. For example, in some instances, the most relevant and/or useful credit score recommendations are arranged at a top of the list of credit score recommendations within the graphical user interface. The credit score recommendations may then be arranged in descending order of relevance from top to bottom within the graphical user interface. Furthermore, in some instances, the credit score indication circuit 128 only includes a predetermined number of credit score recommendations on the graphical user interface. Accordingly, in some instances, the credit score indication circuit 128 omits one or more credit score recommendations that are estimated to be less relevant and/or useful to the customer.

In some instances, the credit score indication circuit 128 is further configured to utilize various feedback information (e.g., credit score recommendations actually acted on by the customer) received from the customer (e.g., via the customer device 102) to retrain or otherwise update the one or more machine learning models. Accordingly, in some instances, the credit score indication circuit 128 rearranges the credit score recommendations and/or add or remove credit score recommendations on the graphical user interfaces described herein based on the updated machine learning models and their associated outputs. For example, as shown in FIG. 3, the credit score indication circuit 128 can rearrange the action links 314 to be in an order that the customer is most likely to engage the action links 314, such that the action link 314 that the customer is most likely to engage with is listed first, the action link 314 that the customer is next most likely to engage with is listed second, and so on for each action link 314.

With reference again to FIG. 2, after the appropriate graphical user interface (e.g., graphical user interface 300 or graphical user interface 400) has been displayed to the customer, at step 208, the credit score indication circuit 128 may then receive a customer approval, at step 210. In some instances, as discussed above, the customer approval is received from one of the transaction processing device 106, another point-of-sale device coupled to the merchant computing system 104, or the customer device 102 (e.g., via the customer selecting the proceed to checkout button 310 on the graphical user interface 300 or the approve purchase button 410 on the graphical user interface 400). In some instances, the customer approves the purchase by re-tapping the customer device 102 to the transaction processing device 106 or another point-of-sale device coupled to the merchant computing system 104 to approve of the purchase using an NFC communication.

Upon receiving the customer approval, the provider computing system 110 then completes the customer transaction, at step 212. For example, in some instances, upon receiving the transaction request over the established payment network, the account processing circuit 126 puts a hold on the transaction and triggers the credit score indication circuit 128 to provide at least one of the graphical user interfaces discussed above to the customer. Accordingly, upon receiving approval of the purchase from the customer, the credit score indication circuit 128 provides an indication of approval to the account processing circuit 126, which then releases the hold and completes the transaction as requested.

In some instances, the method 200 described above includes additional or fewer steps to those described above. For example, in some instances, the credit score indication circuit 128 is configured to only perform steps 206-210 upon determining that the credit score effect exceeds a predetermined threshold. That is, upon determining that a credit score effect associated with an initiated purchase is below a predetermined threshold (e.g., the initiated purchase will reduce the customer's credit score by less than 10 points), the credit score indication circuit 128 is configured to skip or otherwise omit steps 206-210 and automatically transmit an indication of approval to the account processing circuit 126, which then completes the transaction as requested (e.g., at step 212). Alternatively, upon determining that the credit score effect associated with the initiated purchase is above the predetermined threshold, the credit score indication circuit 128 performs steps 206-210 as described above.

In some instances, the predetermined threshold is adjustable by the customer. For example, the customer may not wish to receive any recommendations and/or credit score indicators if a given purchase will not affect or will have only a minor effect on the customer's credit score. Accordingly, in some instances, the customer is able to modify the predetermined threshold. For example, in some instances, the customer is capable of modifying the predetermined threshold within a banking application provided by or otherwise supported by the provider computing system 110 (e.g., one of the client applications 120 stored on the customer device 102). In some instances, the customer is capable of modifying the predetermined threshold via a website hosted or otherwise supported by the provider computing system 110.

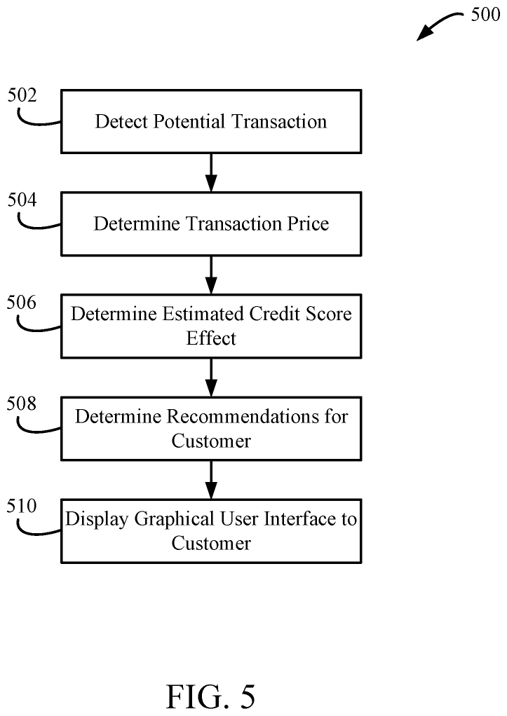

Referring now to FIG. 5, a flow diagram of a method 500 for providing a credit score indicator and credit score suggestions to a customer prior to performing a transaction is shown, according to an example embodiment. In some instances, the method 500 is performed or otherwise executed using various components of the computing environment 100.

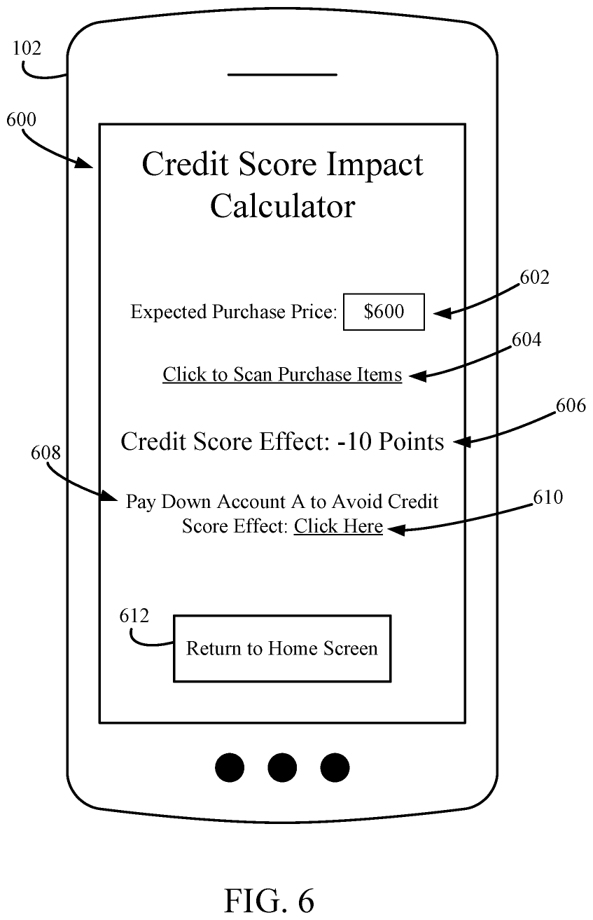

The method 500 begins with the provider computing system 110 (e.g., the credit score indication circuit 128) detecting a potential transaction, at step 502. For example, in some instances, the credit score indication circuit 128 detects a potential transaction based on the customer accessing a credit score impact calculator tool (e.g., graphical user interface 600 shown in FIG. 6) via a banking application (e.g., one of the client applications 120) on the customer device 102, as will be described below.

In some instances, the credit score indication circuit 128 detects a potential transaction using a location of the customer device. For example, in some instances, a banking application (e.g., one of the client applications 120) stored on the customer device 102 is configured to monitor the location of the customer device 102 and automatically transmit a notification to the credit score indication circuit 128 upon the customer device 102 entering a merchant location. Similarly, in some instances, the banking application stored on the customer device 102 is configured to detect a merchant location network (e.g., a Wi-Fi network, a Bluetooth network) and, upon detecting the merchant location network, automatically transmit a notification to the credit score indication circuit 128 indicating that the customer device 102 has entered the merchant location. In some other instances, the credit score indication circuit 128 is configured to continuously or periodically pull location data from the customer device 102 (e.g., via one or more API pulls) and compare the location data to the locations of various merchant locations to determine whether the customer device 102 has entered one of the merchant locations.

Once the credit score indication circuit 128 detects the potential transaction, at step 502, the credit score indication circuit 128 then determines an estimated transaction price, at step 504. For example, in some instances, the customer enters an expected transaction price into a credit score impact calculator tool (e.g., via graphical user interface 600) using a banking application on the customer device 102, as will be described below. In some instances, the customer uses the customer device 102 to scan (e.g., via a camera of the customer device 102) various items they intend to buy as they shop within a merchant point of sale, as will also be described below.

Alternatively, in some instances, instead of the customer providing an expected transaction price or scanning items as they shop, the credit score indication circuit 128 estimates the transaction price based on the merchant location that the customer has entered. For example, in some instances, the credit score indication circuit 128 is configured to detect the customer device 102 entering a particular merchant location and automatically pull payment history for the customer at that merchant location. In some instances, the credit score indication circuit 128 then uses an average purchase price for a predetermined period of time (e.g., the last year, the last five years) as the estimated transaction price. In some instances, the credit score indication circuit 128 instead pulls payment history at the merchant location for all customers (e.g., all customers having accounts held by the provider and stored within the provider account database 124) or a subset of customers similar to the customer associated with the customer device 102. Accordingly, in these instances, the credit score indication circuit 128 uses one or more of an average purchase price for other customers or an average purchase price for other similar customers (e.g., customers having similar credit scores, income levels, geographical locations, levels of debt) as the estimated transaction price. In some instances, the credit score indication circuit 128 additionally uses various contextual information (e.g., time of day, time of week, spending habit patterns of the customer and/or similar customers, whether the customer used public transit to get to the merchant location) to estimate the transaction price.

For example, in some instances, the credit score indication circuit 128 is configured to estimate the transaction price at various merchant locations using one or more machine learning models of the credit score indication circuit 128. In some instances, the credit score indication circuit 128 trains the one or more machine learning models to estimate the transaction price at various merchant locations using a variety of training data. In some instances, the training data comprises historical purchase information associated with the customer, historical purchase information associated with other customers similar to the customer, and/or historical purchase information associated with all customers (e.g., all customers having accounts with the provider). In some instances, the historical purchase information for the customer, similar customers, and/or all customers includes a merchant location, a purchase price, purchase time information (e.g., date and time of day), and/or various other contextual information associated with each purchase (e.g., the corresponding customer's credit score, income level, debt amount, credit utilization, etc., at the time of the purchase, what was what was the corresponding customer doing before making the purchase). Accordingly, in some instances, at least a portion of the training data is data compiled over time from a variety of customers associated with the provider and stored within a database associated with the provider computing system 110 (e.g., the provider account database 124).

Accordingly, once the one or more machine learning models have been trained, the credit score indication circuit 128 may apply various information associated with the potential transaction (e.g., the merchant location, various customer information pulled from the provider account database 124, the time and date, etc.) to the one or more machine learning models to estimate the transaction price. In some instances, the credit score indication circuit 128 is further configured to utilize various feedback information (e.g., an actual price of a purchase made by the customer at the merchant location) received from the customer (e.g., via the customer device 102) or detected by the credit score indication circuit 128 (e.g., based on a transaction indication received by the credit score indication circuit 128 from the account processing circuit 126 upon the customer completing a transaction using a payment account associated with the provider and held within the provider account database 124) to retrain or otherwise update the one or more machine learning models.

Once the credit score indication circuit 128 has determined the transaction price, at step 504, the credit score indication circuit 128 then determines the estimated credit score, at step 506, and determines recommendations for the customer, at step 508. For example, the credit score indication circuit 128 is configured to determine the estimated credit score as described above, with respect to step 204 of the method 200. Further, in some instances, the various recommendations determined by the credit score indication circuit 128 are substantially similar to the various recommendations discussed above, with respect to step 206 of the method 200. However, in some instances, various additional recommendations may be determined by the credit score indication circuit 128 that are more relevant to customers before they have initiated a transaction.

For example, in some instances, the recommendations determined by the credit score indication circuit 128, at step 508, additionally include one or more of recommending that the customer hold off on making a potential purchase until a later date (e.g., “You will receive your paycheck next Monday. If you wait until next Monday and pay down your balance on credit account A prior to making this purchase, you will avoid a negative credit score impact”), recommending that the customer spend no more than a threshold amount while shopping at a given merchant (e.g., “if you spend less than $200 while shopping at merchant B, your credit score will not be negatively impacted”), and/or any other relevant recommendation, as desired for a given application.

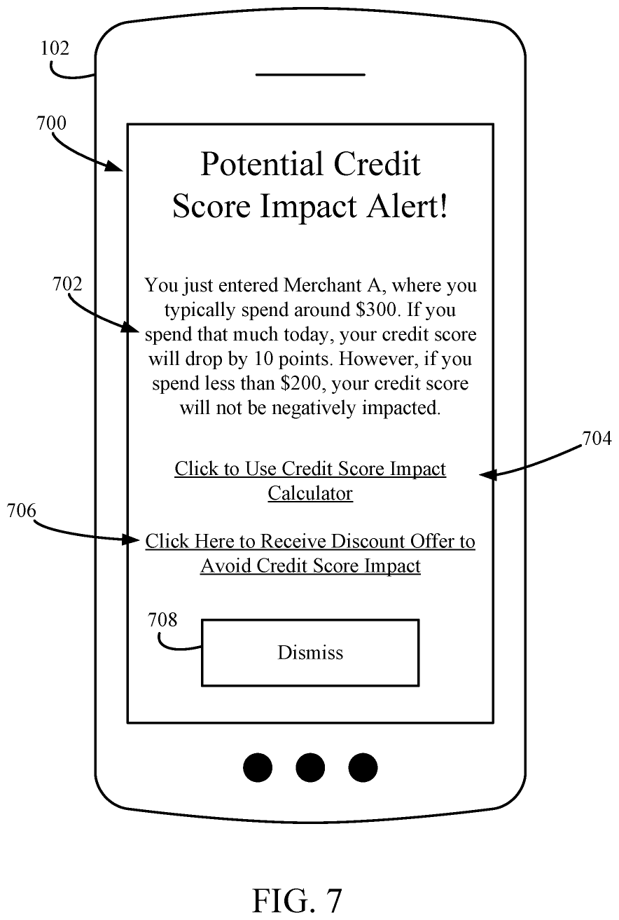

Once the credit score indication circuit 128 has determined the transaction price, the estimated credit score effect, and the various recommendations, the credit score indication circuit 128 may then generate a graphical user interface (e.g., graphical user interfaces 600 of FIG. 6, 700 of FIG. 7) to be displayed to the customer, at step 510.

For example, referring to FIG. 6, a graphical user interface 600 is shown on the customer device 102, according to an example embodiment. In some instances, the graphical user interface 600 is displayed to the customer upon the customer selecting a credit score impact calculator tool button on a banking application interface (e.g., via one of the client applications 120 stored on the customer device 102) or via a credit score impact alert interface (e.g., graphical user interface 700 shown in FIG. 7), as will be discussed below.

As illustrated, the graphical user interface 600 includes an expected purchase price entry field 602. The expected purchase price entry field 602 is configured to receive an expected purchase price from the customer. For example, upon tapping on the expected purchase price entry field 602, the customer may be presented with an on-screen number pad or keyboard with which the customer may enter the expected purchase price.

Alternatively, the customer may select to can various purchase items while shopping by selecting an item scanning link 604. For example, upon selecting the item scanning link 604, the customer may be allowed to scan items (e.g., barcodes, quick response (QR) codes, photographs of items, videos of items) as they shop and have the price of each item automatically added to the expected purchase price (e.g., entered within the expected purchase price entry field 602) when it is scanned. For example, in some instances, the credit score indication circuit 128 determines the prices of the various items by transmitting the scanned barcode, QR core, photograph, or video of the item to the merchant computing system 104 and receiving a price associate with the item from the merchant computing system 104.

The graphical user interface 600 further includes a credit score indicator 606. The credit score indicator 606 is substantially similar to the credit score indicators 306, 406. However, in some instances, the credit score indicator 606 is automatically updated by the credit score indication circuit 128 every time that the customer updates the expected purchase price (e.g., by entering a new expected purchase price within the expected purchase price entry field 602 or by scanning a new purchase item).

The graphical user interface 600 further includes a credit score recommendation 608 and associated action link 610. In some instances, the credit score recommendation 608 is similar to the same as any of the credit score recommendations 308 discussed above. In some instances, the graphical user interface 600 includes a plurality of credit score recommendations. Further, in some instances, the credit score indication circuit 128 similarly identifies and selects the most relevant and/or useful credit score recommendation(s) to include on the graphical user interface 600 using one or more machine learning models, as described above with respect to the credit score recommendations included on or accessible from the graphical user interfaces 300, 400 shown in FIGS. 3 and 4. The action link 610 is similarly configured to allow the customer to perform the corresponding action (e.g., similar to the action links 314).

The graphical user interface 600 further includes a return to home screen button 612. For example, as discussed above, in some instances, the graphical user interface 600 is presented based on the customer selecting to use the credit score impact calculator tool via a banking application and/or a website hosted or otherwise supported by the provider. Accordingly, the return to home screen button 612 allows the customer to return to the corresponding home screen of the banking application and/or the website.

Referring now to FIG. 7, a graphical user interface 700 is shown on the customer device 102. For example, in some instances, the graphical user interface 700 is generated by the credit score indication circuit 128 and transmitted to the customer device 102 upon the customer (and thus the customer device 102) entering a particular merchant location, as discussed above.

As illustrated, the graphical user interface 700 includes a prompt 702 that provides an alert and various relevant information to the customer regarding a potential transaction. For example, in some instances, the prompt 702 provides the customer with an indication of an estimated purchase amount and corresponding credit score impact. While the example shown in FIG. 7 indicates that the estimated purchase amount is based on the average amount that the customer spends at merchant A, in other instances, the estimated purchase amount may be based on other similar customers, other customers generally, or determined in other manners, as described above.

Additionally, in some instances, the prompt 702 includes an indication of a price threshold associated with avoiding a negative credit score impact. For example, in some instances, the credit score indication circuit 128 is configured to determine a maximum amount that the customer can spend without negatively impacting his or her credit score using similar techniques used to determine the credit score impact of the determined purchase price discussed above, with respect to step 204 and step 506 of the method 200 and the method 500, respectively (e.g., progressively determining the credit score impacts of higher purchase prices until there is a negative credit score impact). Accordingly, in some instances, the prompt 702 specifies that if the customer spends less than the price threshold (e.g., “less than $200”), the customer's credit score will not be negatively impacted. In some instances, the graphical user interface 700 further includes a credit score impact calculator link 704. Accordingly, upon receiving the potential credit score impact alert provided by prompt 702 on the graphical user interface 700, the customer may navigate to the credit score impact calculator tool (e.g., the graphical user interface 600) discussed above to explore the impacts of different potential purchases prices of purchases made at the merchant location.

In some instances, the graphical user interface 700 further includes one or more offer links 706 configured to provide the customer with one or more corresponding credit-score-related offers. For example, in some instances, the provider (e.g., the provider computing system 110) and/or the merchant (e.g., the merchant computing system 104) may offer the one or more credit-score-related offers to the customer as an additional incentive for the customer to avoid negatively impacting his or her credit score.

For example, as discussed above, in some instances, the credit score indication circuit 128 is configured to determine a maximum amount that the customer can spend without negatively impacting his or her credit score. Accordingly, in some instances, the merchant computing system 104 and/or the provider computing system 110 are configured to provide a discount offer to the customer configured to encourage the customer to spend the maximum amount or less. For example, if the maximum amount the customer can spend without negatively impacting his or her credit score is $90, the merchant computing system 104 and/or the provider computing system 110 may provide a 10% off discount offer or coupon for purchase totals of $100 or less, such that the after-discount or after-coupon total spent by the customer is $90 or less, thereby avoiding a negative impact on the customer's credit score. In some instances, the discount or coupon may be a flat rate. In other instances, the discount or coupon may be tiered depending on the credit score purchase and/or may be tied to specific products or services offered by the merchant.

Accordingly, the graphical user interface 700 provides an alert to the customer upon entering a merchant location that an expected or estimated transaction amount associated with that merchant location will negatively impact the customer's credit score, provides access to the credit score impact calculator tool discussed above with respect to FIG. 6, and provides various credit-score-related offers to the customer. As such, the customer is made fully aware of the impact of his or her intended purchase at the merchant location while shopping. After reviewing and/or using the various tools accessible from the graphical user interface 700, the graphical user interface 700 further includes a dismiss button 708 configured to return the customer to a home screen of the customer device.

In some instances, various features of the graphical user interfaces described herein (e.g., graphical user interface 300, 400, 600, 700) may be arranged differently and/or additional or alternative features may be included within the graphical user interfaces, without departing from the scope of the present disclosure. Furthermore, in some instances, various functionality described herein, with reference to the various graphical user interfaces, may alternatively be provided via one or more artificial-intelligence-based chatbots (e.g., utilizing large language models and/or generative pre-train transformer neural network models) configured to converse with the customer via a verbal or text-based conversation.

For example, in some instances, if the credit score indication circuit 128 detects an initiated or potential transaction, the credit score indication circuit 128 causes a banking application (e.g., one of the client applications 120) running on the customer device 102 to automatically open an AI-based chatbot window configured to walk through one of more prompts and/or actions with the customer. For example, in some instances, in some instances, the AI-based chatbot indicate to the customer how an initiated or potential future purchase will affect the customer's credit score, and the customer can converse (e.g., verbally or via a text-based input) with the AI-based chatbot to determine how different purchase prices will affect the customer's credit score (e.g., “Will a $500 purchase affect my credit score?”) and/or to determine the maximum amount that the customer can spend without negatively impacting his or her credit score (e.g., “How much can I spend without negatively impacting my credit score?”).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system comprising:
one or more processing circuits including one or more processors coupled to one or more memory devices, the one or more memory devices having instructions stored thereon that, when executed by the one or more processors, cause the one or more processors to:
receive an indication of a customer transaction associated with a customer, the indication of the customer transaction including a transaction amount;
determine a credit score effect associated with the customer transaction based on the transaction amount;
generate display data including a credit score indicator indicative of the credit score effect; and
cause a graphical user interface, based on the display data, to be displayed to the customer prior to completion of the customer transaction.

2. The computing system of claim 1, wherein the instructions further cause the one or more processors to:
retrieve customer information associated with the customer; and
determine one or more credit score recommendations for the customer based on one or more of the credit score effect, the transaction amount, or the customer information,
wherein the display data further includes the one or more credit score recommendations.

3. The computing system of claim 2, wherein the display data further includes one or more action links corresponding to the one or more credit score recommendations, each of the one or more action links being selectable to allow the customer to perform an action associated with the corresponding credit score recommendation.

4. The computing system of claim 1, wherein the instructions further cause the one or more processors to compare the credit score effect to a threshold credit score effect, and wherein generating the display data and causing the graphical user interface to be displayed to the customer are performed responsive to the credit score effect exceeding the threshold credit score effect.

5. The computing system of claim 1, wherein receiving the indication of the customer transaction comprises detecting that a customer device associated with the customer has entered a merchant location.

6. The computing system of claim 5, wherein the customer transaction is a potential customer transaction, the transaction amount is an estimated transaction amount, and the instructions further cause the one or more processors to:
retrieve purchase history information associated with the merchant location; and
determine the estimated transaction amount based on the purchase history information associated with the merchant location.

7. The computing system of claim 6, wherein the purchase history information includes information associated with one or more of the customer or other customers similar to the customer.

8. The computing system of claim 1, wherein the credit score indicator is one of a text-based, a color-based, or a symbol-based indicator.

9. A method comprising:
receiving an indication of a customer transaction associated with a customer, the indication of the customer transaction including a transaction amount;
determining a credit score effect associated with the customer transaction based on the transaction amount;
generating display data including a credit score indicator indicative of the credit score effect; and
causing a graphical user interface, based on the display data, to be displayed to the customer prior to completion of the customer transaction.

10. The method of claim 9, further comprising:
retrieving customer information associated with the customer; and
determining one or more credit score recommendations for the customer based on one or more of the credit score effect, the transaction amount, or the customer information,
wherein the display data further includes the one or more credit score recommendations.

11. The method of claim 10, wherein the display data further includes one or more action links corresponding to the one or more credit score recommendations, each of the one or more action links being selectable to allow the customer to perform an action associated with the corresponding credit score recommendation.

12. The method of claim 9, further comprising comparing the credit score effect to a threshold credit score effect, and wherein generating the display data and causing the graphical user interface to be displayed to the customer are performed responsive to the credit score effect exceeding the threshold credit score effect.

13. The method of claim 9, wherein receiving the indication of the customer transaction comprises detecting that a customer device associated with the customer has entered a merchant location.

14. The method of claim 13, wherein the customer transaction is a potential customer transaction, the transaction amount is an estimated transaction amount, and the method further comprises:
retrieving purchase history information associated with the merchant location; and
determining the estimated transaction amount based on the purchase history information associated with the merchant location.

15. The method of claim 14, wherein the purchase history information includes information associated with one or more of the customer or other customers similar to the customer.

16. The method of claim 9, wherein the credit score indicator is one of a text-based, a color-based, or a symbol-based indicator.

17. A non-transitory computer-readable medium having instructions stored thereon that, when executed by at least one processing circuit of a computing system, cause operations comprising:
receiving an indication of a customer transaction associated with a customer, the indication of the customer transaction including a transaction amount;
determining a credit score effect associated with the customer transaction based on the transaction amount;
generating display data including a credit score indicator indicative of the credit score effect; and
causing a graphical user interface, based on the display data, to be displayed to the customer prior to completion of the customer transaction.

18. The non-transitory computer-readable medium of claim 17, wherein the operations further comprise:
retrieving customer information associated with the customer; and
determining one or more credit score recommendations for the customer based on one or more of the credit score effect, the transaction amount, or the customer information,
wherein the display data further includes the one or more credit score recommendations.

19. The non-transitory computer-readable medium of claim 17, wherein the operations further comprise comparing the credit score effect to a threshold credit score effect, and wherein generating the display data and causing the graphical user interface to be displayed to the customer are performed responsive to the credit score effect exceeding the threshold credit score effect.

20. The non-transitory computer-readable medium of claim 17, wherein receiving the indication of the customer transaction comprises detecting that a customer device associated with the customer has entered a merchant location.
